(19) United States
(12) Patent Application Publication
(10) Pub. No.: US 2008/0054827 A1
(43) Pub. Date: Mar. 6, 2008

(54) POWER SYSTEM RATING CONVERTER

(76) Inventors: Derek States, Bangkok (TH); David States, Pleasant View, UT (US)

Correspondence Address: PATE PIERCE & BAIRD, 175 SOUTH MAIN STREET, SUITE 1250, SALT LAKE CITY, UT, 84111, US

(21) Appl. No.: 11/845,654

(22) Filed: Aug. 27, 2007

Related U.S. Application Data
(60) Provisional application No. 60/840,829, filed on Aug. 29, 2006.

(51) Int. Cl. H02P 5/00; H02K 7/02; H02K 53/00

(52) U.S. Cl. 318/108; 318/161; 74/DIG. 9

(57) ABSTRACT

A system comprising at least one flywheel, a first motor, a dynamo, and a second motor. The first motor may consuming electrical power and urging rotation of the flywheel. The dynamo may use rotational energy received from the flywheel to generate electrical power. The second motor may consuming at least a portion of the electrical power generated by the dynamo. Also, the second motor may have a rating corresponding to a maximum consumption of electrical power that is more than double the maximum consumption of electrical power of the first motor.

### RELATED APPLICATIONS

This application claims the benefit of U.S. Provisional Patent Application Ser. No. 60/840,829 filed Aug. 29, 2006, which is hereby incorporated by reference.

### BACKGROUND

1. The Field of the Invention

This invention relates to electrical power generation and, more particularly, to novel systems and methods for utilize stored kinetic energy to overcome certain obstacles typically found in electrical power generation systems.

2. The Background Art

In various environments, power may be available in only one mode. For example, in third world countries, single phase power may be available. Also, that power may only be available on a limited basis. By contrast, various industrial equipment may require three phase power or greater power infrastructure that is available.

Also, most electrical equipment has the ability to operate with a much lower power rating than may at first appear. For example, electrical equipment typically draws maximum current at zero velocity. A motor may draw maximum current in a stalled configuration. Thus, at start-up, an electrical motor may draw maximum current and must receive the full, rated load.

However, once a motor is operated it may never draw its rated current unless it again is stalled. That is, if a load is so large that it brings the engine to a virtual stop, then the motor may again draw full current. This is the situation that results in failed motors. That is, the motor may stall and draw too much current for too long, resulting in overheating, melted insolation, electrical shorts, and destruction of the motor.

Nevertheless, since most electrical equipment does not actually operate at its fully rated load, it does not actually require during operation an infrastructure that supports the fully rated load. What is needed is a mechanisms that bridges the gap between the available electrical infrastructure and the requirements of typical industrial equipment.

### BRIEF SUMMARY OF THE INVENTION

In view of the foregoing, in accordance with the invention as embodied and broadly described herein, a method and apparatus are disclosed in one embodiment of the present invention as including an improved system for surviving initial transients and supporting the operation of electrical equipment at its actual operating requirements. In one embodiment, an apparatus in accordance with the invention may rely on an initial power source or motor. For example, a comparatively smaller electrical motor (e.g., a five horse power motor) may operate as a single phased or multi-phased device from the current and voltage typically available. Opposite this comparatively lower rated system may be a dynamo or generator providing power to a larger motor (e.g., a fifty horse power motor), which may operate at a different phase, such as a three-phase configuration.

Between the comparatively lower powered motor, and the dynamo supporting a larger motor may be a mechanical buffer storing mechanical energy. The buffer or kinetic energy storage device may store energy deliverable to the dynamo. The kinetic energy storage device may accommodate and ameliorate start-up transients of the larger motor driven by the dynamo.

In one embodiment, the dynamo may be configured to keep the windings as close to the central shaft as possible, which may provide improved magnetic performance in a minimum envelope. Accordingly, in certain embodiments the dynamo may provide increased magnetic fields over conventional apparatus designed for similar purposes.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic plot diagram of an apparatus in accordance with the invention;

FIG. 2 is perspective view of one embodiment of the mechanical and electrical apparatus implementing the apparatus of FIG. 1;

FIG. 3 is a perspective view of one embodiment of staged apparatus in accordance with the invention;

FIG. 4 is a perspective view of one embodiment of a dynamo in accordance with the invention for use in the system of FIG. 1;

FIG. 5 is a perspective view of one embodiment of a rotor for the dynamo of FIG. 4;

FIG. 6 is an end elevation view of one embodiment of a magnetic pole plate for the dynamo of FIG. 4;

FIG. 7 is a perspective view of a partially disassembled shaft and two poles of the dynamo of FIG. 4;

FIG. 8 is a perspective view of the assembled poles of the dynamo in FIG. 1, absent the windings around the poles;

FIG. 9 is a front elevation view of a control panel for the control system of an apparatus in accordance with the invention;

FIG. 10 is a schematic diagram of one embodiment of an exciter circuit in accordance with the invention; and

FIG. 11 is a schematic block diagram of a method for operating an apparatus in accordance with the invention.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

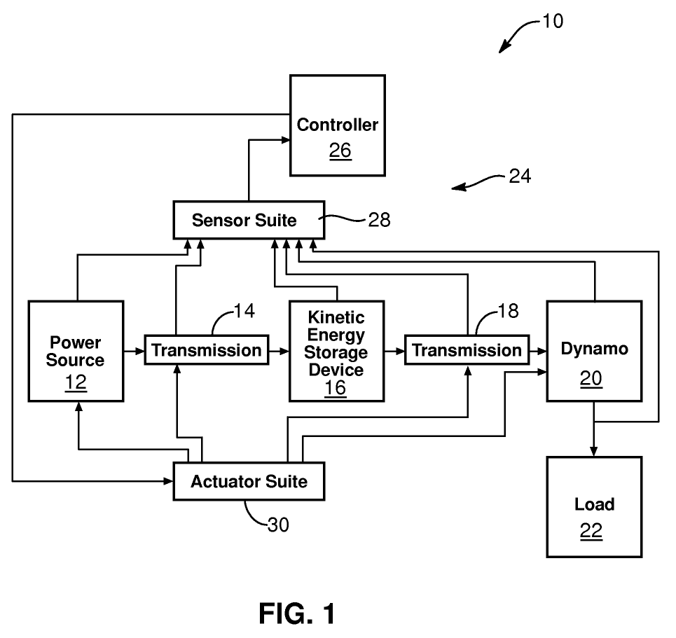

Referring to FIG. 1, a system 10 may include a power source 12 operating through a transmission 14 to deliver energy to a kinetic energy storing device 16. The power source 12 may actually be any power source whether mechanical, hydrodynamic, chemical, or the like. In certain embodiments, the power source 12 may be a motor connected to a local infrastructure of a village, community, industrial plant, or the like

In the illustrated embodiment, the storage device 16 may transmit power through a transmission 18 to a dynamo 20, generator 20, or the like. The dynamo 20 may, in turn, service a load 22 such as a motor. In the illustrated embodiment the power source 12 may typically be a motor having a substantially lower rating, and even a different phase arrangement than the load 22 serviced by the dynamo 20.

For example, an apparatus in accordance with the invention was developed having a power source 12 rated at about 5 horsepower. By contrast, the load 22 was a 25 horsepower motor driving a process in an industrial environment with a duty cycle of about 75%. Accordingly, the load 22 appeared to be drawing 25 horse power on a 75% duty cycle. As a practical matter, however, the power source 12 having only a rating of 5 horse power was adequate.

It should be understood that a load 22 may be rated in order to operate in all circumstances. The start-up load, or the start-up current drawn by a load 22 may be significant. Accordingly, the motor representing the load 22 must have wiring, voltage, insolation, and so forth properly rated for start-up. In the illustrated embodiment, an apparatus actually tested relied on the kinetic energy storage device 16 to provide the start-up energy to the dynamo 20 serving the load 22. In this way, the buffer provided by the storage device 16 provided the rating demand by the load 22. The power source 12 was never required to support that demand on a moment-by-moment basis.

A dynamo 20 and load 22 may be selected with a rating much greater than that of the power source 12. Nevertheless, in an apparatus 10 in accordance with the invention, a derating is possible by simply overcoming any transient conditions imposed by the load 22. Accordingly, so long as the kinetic energy storage device 16 is capable of supporting the transient power drawn by the load 22, the power source 12 may be derated far below the power rating of the dynamo 20 or generator 20. For example, in selected embodiments, the rating of a power source 12 may be as small as one tenth the power rating of the dynamo 20 or load 22.

In the illustrated embodiment, a control system 24 may act to control the mechanical electrical equipment and connections therebetween. In selected embodiments, a control system 24 may include a controller. A controller 26 may be a processor-based controller, an analog controller, or some combination thereof. In general, the controller 26 receives information from a sensor suite 28. The sensor suite 28, in turn receives position, rotational speeds, power, current, and voltage readings, or the like, by electrical, mechanical, or other data transmission formats from one or more of the power source 12, transmission 14, storage device 16, transmission 18, dynamo 20, and a line to the load 22. A sensor suite 28 may measure any electrical or mechanical signal by measurement and reporting mechanisms as known in the art. For example, strip chart recorders, mechanical dials, gages, various types of meters, and data outputs may be incorporated within sensor suite 28.

Likewise, an actuator suite 30 may act to impose conditions or instructions in order to control the power source 12, transmission 14, energy storage device 16, transmission 18, dynamo 20, load 22, alone, individually, or in combination as needed. In one embodiment, the controller 26 may provide digital processor control of the actuator suite 30. Accordingly, the actuator suite 30 may include mechanical, electrical, and data inputs to anyone of the elements 12, 14, 16, 18, 20, 22 in the system 10. For example, the actuator suite 30 may include controllers and solenoids to disengage clutches in the transmissions 14, 18, or to actuate a break on the energy storage device 16, or to provide an excitation voltage to a dynamo 20, and so forth.

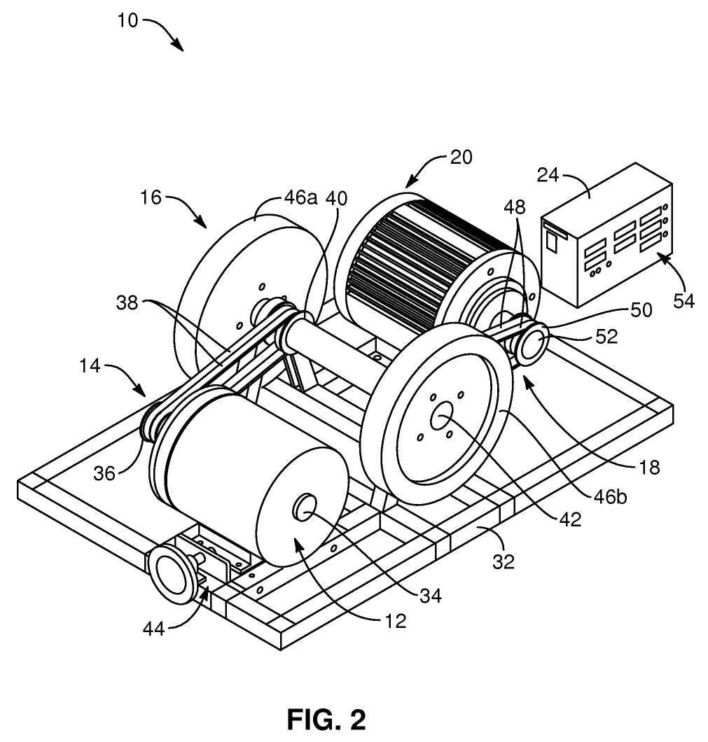

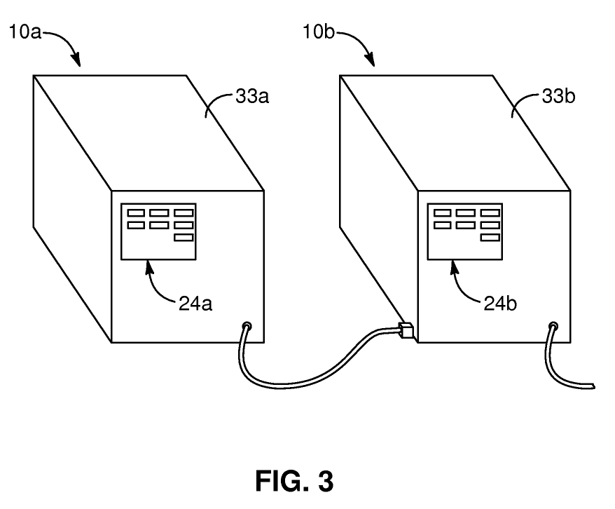

Referring the FIGS. 2-3, an apparatus 10 in accordance with the invention may include a frame 32. A frame 32 may include or be covered by an enclosure 33. In the illustrated embodiment, the frame 32 may support power source 12 rotating a shaft 34, which may in turn drive one or more pulleys 36 secured thereto. For example, a pulley 36 may connect to a belt 38. In the illustrated embodiment, a pair of pulleys 36 drive multiple belts 38 rotating a pulley 40 and shaft 42 associated with the kinetic energy storage device 16. With each pulley 36, 40 rigidly secured to its corresponding shaft 34, 42, the belts 38 may drive the shafts 34, 42 at the respective angular velocities determined by the ratios of the diameters of their respected pulleys 32, 40.

In certain embodiments, it has been found that the pulleys 36, 40 may be separated from direct operation with one another by a transmission 14 or clutch mechanism 14. The clutch may be a plate, a hydrodynamic type, or the like. In certain embodiments, a tensioning clutch may simply release the tensions on the belts 38, thus reducing friction to such a low level that no significant damage is done to the belts 38, yet the belts 38 do not engage the pulleys 36, 40.

Whether used for clutching, or simply for maintaining proper frictional loads, the belts 38 may be tensioned by movement of the shaft 34. For example, the power source 12 may be mounted to the frame 32 in such a way as to be slidable moveable. In selected embodiments, a tensioner 44 may slide the mount below the power source 12 along the frame 32 in order to put more or less tension on the belts 38. Other mechanisms that operate more rapidly may include levers, and the like. For example, an idler wheel on a lever may also add tension to the belts 38. By being moved between an engaged position and a disengaged position, an idler, may take up slack in the belts 38, thus controlling the tension. Such a mechanism may provide clutching (e.g., form a transmission 14) between the two pulleys 36, 40, by releasing the tension, or simply controlling the tension in an orderly fashion in order to spin the shaft 42 up to operating speeds.

In certain embodiments, an energy storage device 16 may be embodied as one or more flywheels 46 or weighted wheels 46. A flywheel 46 in accordance with the present invention may be of any suitable size. Accordingly, for example, a pair of flywheels 46a, 46b having a diameter of from about one to three feet, may rotate with the shaft 42 of the system 10. In one embodiment, flywheels 46 having diameters of about two feet may successfully operate between a power source 12 rated at about 10 horsepower a load 22 rated at about 25 horsepower.

Just as a first transmission 14 maybe implemented as a system of belts 38 and pulleys 36, 40 a second transmission 18 may be implemented in the same or different manner. For example, gear drives are possible. However, gear drives tend to require more precision. Likewise, the systems of belts 38, 48 in the illustrated embodiment may be implemented in comparatively low-technology environments. Technology has provided belts for automobiles that withstand many millions of cycles before failure. Meanwhile, traditionally, various types of belts 38,48 have been made of leather and other natural materials. Accordingly, an apparatus 10 in accordance with the invention may be implemented in a very robust arrangement such that native materials and technologies may still be applied when needed. Nevertheless, the transmissions 14,18, maybe implemented in any suitable format including the use of belts, gears, chains, sprockets, hydrodynamic circuits, continuously variable transmissions, plates, and the like.

In one embodiment, a pulley (not shown) on the shaft 42 associated with the energy storage device 16 may drive belts 48 secure to one or more pulleys 50 on the dynamo 20. In the illustrated embodiment, for example, the pulleys 50 attached to a shaft 52 rotate the moveable elements of the dynamo 20 to produce power.

In certain embodiments, a control system 24 may include a user interface 54. A user interface 54 may be adapted to the to provide inputs and outputs useful for an operator. For example, a user interface may include various switches, status indicators, display screens, and the like.

In certain embodiments, a system 10 in accordance with the present invention may be cascaded or staged. That is, multiple systems 10a, 10b may be linked together. This may provide for the output of one system 10a becoming the input for the next system 10b. For example, in one embodiment, flywheels 46 may be manufactured at a maximum available, practical size. If that size is insufficient, then to two or more systems 10a, 10b maybe staged in order to provide additional energy storage. Accordingly, the ultimate output of the systems 10a, 10b may be able to tolerate greater transients, by virtue of additional storage devices 16 and storage capacity. However, in selected embodiments, certain additional stages 10 may omit the kinetic energy storage device 16.

Referring to FIG. 4, an apparatus 10 may include a dynamo 20. A dynamo 20 may be selected or sized to provide the desired output. Accordingly, dynamos 20 of a wide range may be suitable for use in accordance with the present invention. For example, in one embodiment, a dynamo 20 may be rated as a twenty-five kilowatt power generator. In certain embodiments, a dynamo 20 may receive a low amperage direct current (DC) voltage in conjunction with mechanical rotation to generate a three phase, high amperage, fifty to sixty Hertz, alternating current (AC) output voltage. A dynamo 20 in accordance with the present invention may be incorporate the ability to turn the exciter voltage on and off. A dynamo 20 may also include dual stator windings, make the invention uniquely powerful.

A dynamo 20 in accordance with the present invention may run very cool and not generate much heat due. It may also be lightweight, portable, and robust. The input DC voltage may typically range from about 12 VDC to about 48 VDC and may be increased in about 2-volt increments. The incremental DC voltage may stabilize the output voltage resulting from load variations.

In selected embodiments, a dynamo 20 may rotate at approximately 1500 RPM (e.g., in a 50 Hz system). Other rotational speeds may also be implemented. For example, a 60 Hz system may rotate at about 1800 RPM. Eddy current losses associated with a dynamo in accordance with the present invention may be less than those of previous devices, making it much more efficient. In one embodiment, a twenty-five kilowatt dynamo may be about ten inches in diameter and seven inches long. This may be significantly smaller than previous dynamos. The use of high-grade electrical steel may contribute to the efficiency of the Dynamo design.

In certain embodiments, the shaft 52 of a dynamo 20 may freely rotate prior to the DC exciter voltage being applied. Rotating the dynamo 20 to the operational speed (e.g., 1500/1800 RPM or the like) prior to turning on the DC exciter voltage may greatly reduce start-up torsional loads of the dynamo 20. That is, in traditional systems, the DC excitement of a dynamo occurs whenever the system is rotating, causing voltage surges and large initial torsional loads. These voltage surges may damage motor drive systems. A dynamo 20 in accordance with the present invention may generate only a minimal surge.

After establishing a constant rotational speed (e.g., 1500 RPM), the DC excitement current may be switched on. At this point, a dynamo 20 may become an electromagnet producing a torsional load on the system. In selected embodiments, the stator of the dynamo 20 may output a three phase, high amperage, AC voltage.

In certain embodiments, a housing 56 of a dynamo 20 may be provided with convection enhancements 58. For example, fins, oil-filled radiation panels, heat sinks, and the like maybe provide to remove excess heat from the dynamo 20. In certain embodiments, the housing 56 provided with convection enhancements 58 may reject heat to the ambient air or other fluid. Typically, oil cooling may be used in electrical equipment to good effect since many oils are electrical insulators. In other environments, where seals are adequate, and the metals may prevent corrosion, water cooling may be very effective. By any such mode, convection enhancements 58 may improve the rejection of heat due to electrical losses in the dynamo 20 to the environment.

In certain embodiments, a dynamo 20 may include a base 60. A base 60 may mount to the frame 32 of an apparatus 10 in accordance with the invention. The frame 32 and base 60 may be configured to provide relative motion therebetween. That is, for example, the tensioner 44 on the motor 12 or power source 12 may provide control of the tension in the belts 38. By the same token, the belts 48 may be provided with a relief of tension by relative motion between the base 60 and the frame 32.

A dynamo 20 may include a stator internal thereto of any suitable configuration. Typically, the stator will involve cores and windings to maintain the electrical field for generation of electricity. The stator, will typically be configured in conjunction with a rotor to provide the proper sequencing of magnetic pulses there between.

In selected embodiments, the stator of a dynamo 20 in accordance with the present invention may be wound using 18 AWG copper wire and follow the standard “basket” type of winding. When winding the stator, the wire may be wound as a pair of wires. In certain embodiments of the present invention, there may be 36 rooms in a 25 KW dynamo stator housing. That is, there may be four poles in the stator and each pole may contains nine rooms. The rooms in each pole may be wired in series, room by room. Each pole winding may output two wires. At two wires per pole and a total of four poles, eight wires may be connected in parallel to the four stator contact points. The stator wiring may be laminated, thus insulating the stator wiring from the alternator poles.

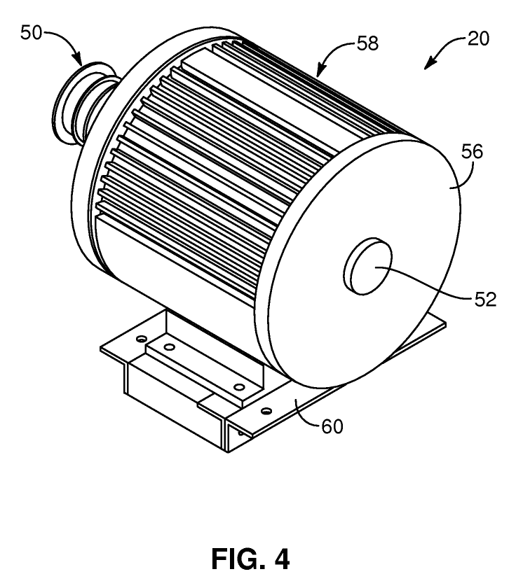

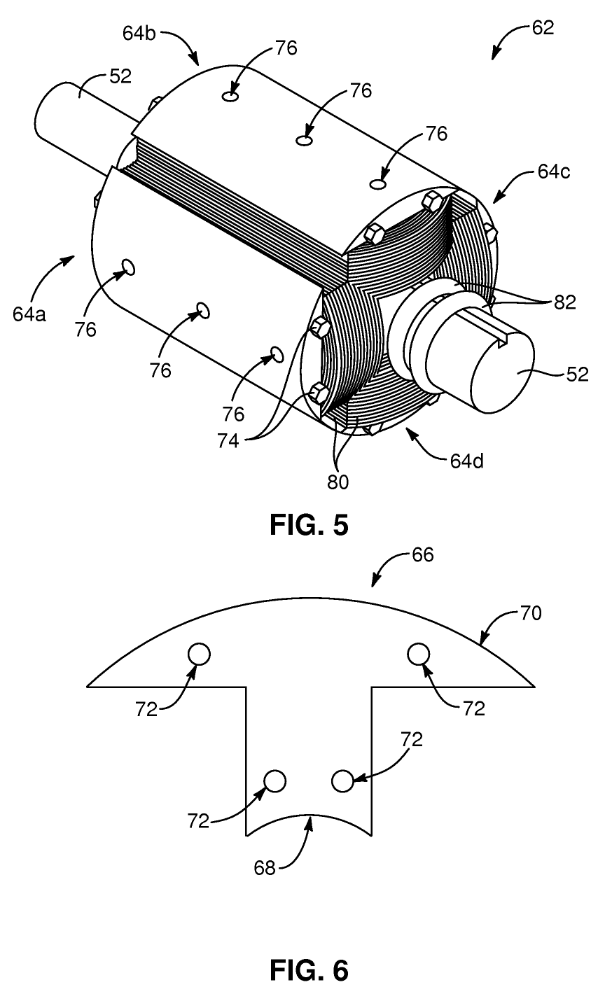

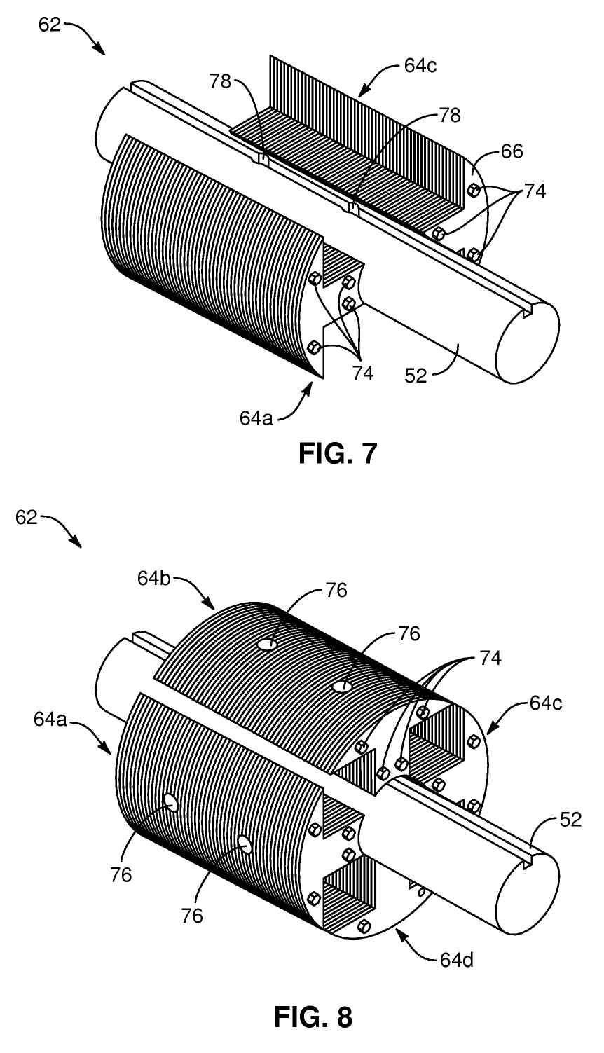

Referring to FIGS. 5-8, in selected embodiments, a rotor 62 may spin within the housing 56 and inside of the stator of a dynamo 20. In the illustrated embodiment, the rotor may be provided with various poles 64. The number of poles 64 may vary to provide the desired result. For example, one dynamo 20 in accordance with the present invention comprises four removable poles 64a, 64b, 64c, and 64d. The poles 64 may be magnetic poles. In selected embodiments, the poles 64 may be made of a series of metal plates 66. For example, the plates 66 may be made from a specially treated, high quality electrical steel. The plates 66 may be thin, small, and insulated. The plates 66 may be symmetric about the center line to avoid imbalance during operation. The plates 66 may also be individually laminated. This lamination may seal and electrically insulate each plate from its adjoining neighbor.

Each of the plates 66 may include an interior edge 68 conformed to the circumference of the shaft 52. The exterior edges 70 of each of the plates 66 may be conformed to an inner diameter of the stator of the dynamo 20. Each of the plates 66 may have a thickness selected to minimize any eddy current losses within the plate 66. Various types of magnet steels from carefully crystallized and oriented metallurgy to amorphous metals may be used. In certain experimental arrangements, plates along the order of 0.050 inches to about 0.075 inches in thickness have been found to operate effectively.

In general, each of the exterior edges 70 of the plates 66 in a single stack effectively conform to a single solid outer surface of that particular respective pole 64. Meanwhile, all of the poles 64, with their corresponding exterior edges 70 form an envelope or circumference defining a circle of rotation. Of course, balancing is extremely important at the high rotational velocities of the shaft 52 and corresponding poles 64.

In certain embodiments, the plates 66 may be provided with apertures 72 aligned to bind tightly together all of the plates 66 in a single pole 64. Accordingly, a variety of apertures 72 may be provided at strategic locations where they may provide the best mechanical advantage and provide the least interference with magnetic activity within the plates 66.

Fasteners 74 may penetrate through the respective apertures 72 securing the poles 64 together. Likewise, apertures 76 formed radially through each of the poles 64 may act to secure the poles 64 on opposite sides of the shaft 52. Apertures 78 may be formed in the shaft 52 to receive the fasteners securing the cores 64 or poles 64 together through the aperture 76.

In certain embodiments, the plates 66 of the rotor 62 may be formed to be a single piece of metal having apertures. That is, the openings illustrated in FIG. 8 between the various magnet cores 64 or poles 64 may actually be formed in single metal plates. However, it has been found that forming the plates 66 to be separated from one another, in an axial direction across the shaft 52 provides a compact, and powerful magnetic force due to the windings 80 acting about the poles 64 or cores 64. Likewise, the metal selected and the thickness of each of the plates 66 reduces losses and appears to substantially improve the magnetic force applied by the magnet poles 64 of the rotor 62.

Each of the poles 64 may be surrounded by a winding a of wire 80. The windings 80 may be formed in accordance with the magnetic equations known in the field of electrical engineering. Input bushings 82 may convey the excitation voltage to the rotor 62. In certain embodiments, commutators may be used in place of the slip rings 82.

For example, in selected embodiments, each pole 64 may be wound with high grade 16 AWG copper wire. The pole windings 82 may be wound with one continuous wire. Each pole 64 may typically have multiple winding layers. All poles 64 may be wired in series. The pole windings may be in contact with the adjacent pole windings at the base of each pole 64. The distance between the pole-to-pole tip edges may be fractional. Paper or other insulation may be laid between the shaft 52 and the pole 64. Paper insulation may also be laid between assembled pole plates 66 and the windings. In selected embodiments, the windings 80 may be inset approximately 0.25 inches from the pole tip edges. So configured, they may never extend past the pole tip edges at any point. The windings on the ends of the poles 64 may extend out approximately 1.0 inches. So configured, they may never extend further than the stator windings. The pole windings may be laminated, thereby insulating the pole wiring 80 from the stator wiring. In selected embodiments, each pole 64 may be wound so that its magnetic poles alternate by one hundred eighty degrees from adjacent poles 64.

In selected embodiments, the two leads from the pole windings may terminate at two copper bushings 82 attached to the shaft 52 of the dynamo 20. The leads may be secured to the bushings 82 by bolts, solder, some combination thereof, or the like. The DC voltage may be input to these bushings 82 via multiple, tension spring brushes. The DC input bushings 82 may be insulated from the shaft 52 and from each other by bakelite, other polymers, or fibers. The bushings 52 may be pressed onto the shaft 52. The section of the shaft 52 between the bushings 82 and the rear may also be fiber insulation, approximately 2.00 to 2.125 inches.

In certain embodiments, a dynamo 20 in accordance with the present invention may include approximately 33% fewer plates and a smaller core diameter than industry standards. For example, the distance between the stator and the rotor 62 may typically be approximately 0.063 inches. In contrast, the current industry standard stator-alternator gap is 0.125 inches.

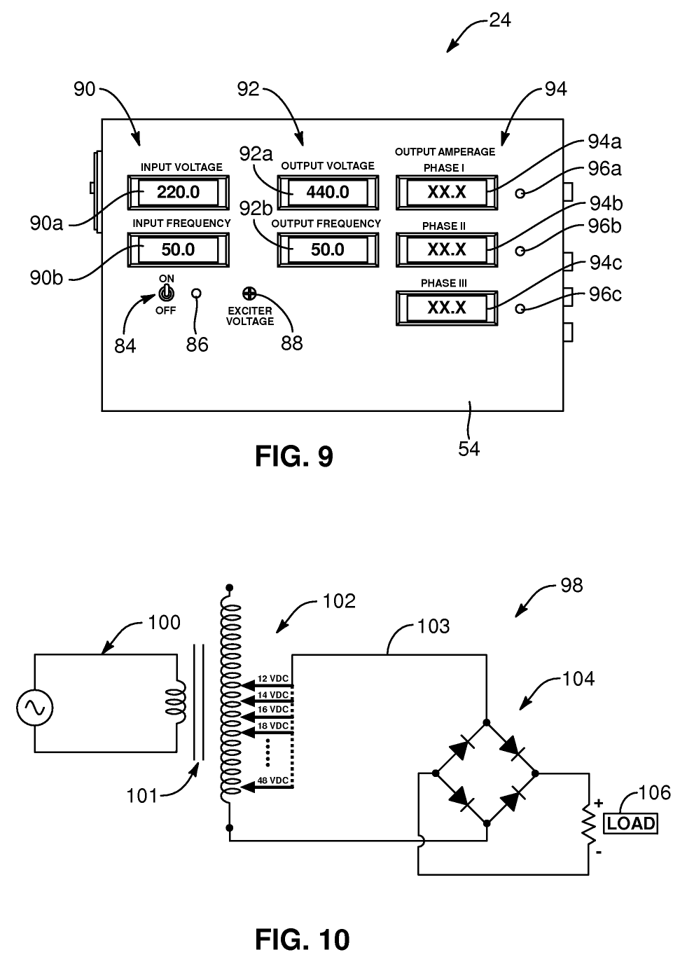

Referring to FIG. 9, a control system 24 may be provided with a user interface 54. For example, the user interface 54 may take the appearance of a control panel 54. In the illustrated embodiments, a switch 84 may provide activation of the apparatus 10. For example, in one embodiment, the switch 84 may actually comprise a series of relays ramping up power to activate the excitation voltage on the dynamo 20. Likewise, the switch 84 may also activate a signal processed by the controller 26 to activate a sequence of events, various powering events, as well as various exchanges of information, such as data between various aspects of the system 10.

In certain embodiments, a status indicator 86 such as a light 86 may indicate that the system is powered up, operable, ready, or the like. Thus, various lights 86 may be implemented in order to show the status of various aspects or elements within the system 10. In one embodiment, an adjustment mechanism 88 may provide control over fine adjustments to the excitation voltage applied to the dynamo 20.

In the illustrated embodiment, one or more input displays 90 may provide information regarding various inputs. For example, an input display 90a may indicate the input voltage, while another input display 90b may identify the corresponding frequency. Likewise, one or more output displays 92 may display various parameters to a user. In the illustrated embodiment, an output display 92a may display output voltage, while another output display 92b may display the corresponding frequency. Meanwhile, various phases may be displayed in one or more phase displays 94, shown here as phase displays 94a, 94b, 94c. In the illustrated embodiment, indicator lights 96 may also indicate whether a particular phase 94 is active.

Referring to FIG. 10, one embodiment of an excitation circuit 98 may include an input circuit 100 providing a current at some voltage. A core 101 may be shared between a coil in the input circle 100 and a coil in the transformed or output circuit 103 of a transformer 102. In the illustrated embodiment, a rectifier bridge 104 or bridge 104 may rectify the current output by the output circuit 103. Accordingly, a load 106 may thus be connected to receive a direct current load even if the original power source is powered from alternating current. In the illustrated embodiment of FIG. 10, a dynamo 20 may be excited by direct current instead of an alternating current. In this embodiment, the load 106 may correspond to the windings 80 on the rotor 62 of the dynamo 20.

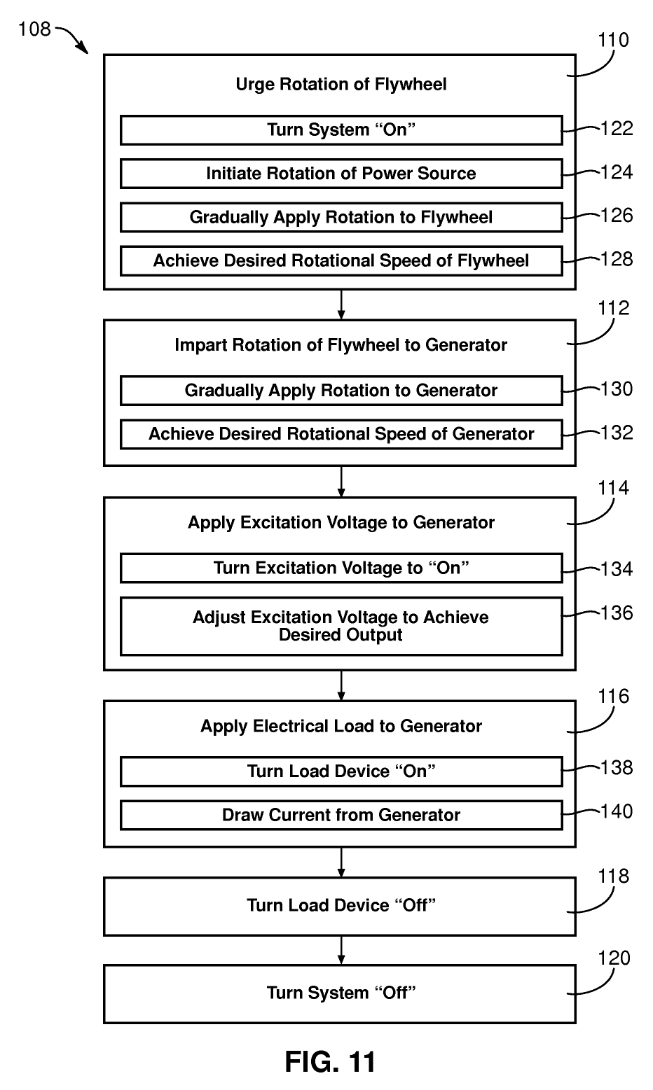

Referring to FIG. 11, a method 108 in accordance with the invention may begin with rotation 110 of the fly wheel. In general, urging rotation 110 may be a process by which the flywheel 106 is energized to bring it up to some operating speed range. That is, the value of a flywheel 46 is its comparatively large stored energy. However, the fact that it becomes a good storage device 46 is the difficulty in urging 110 its rotation.

Rotation may be urged 110 in stages, or slowly, by slipping a clutch, by multiple gears, by shifting up in a transmission, or other mechanisms. In certain embodiments, the process 110 may be followed by the impartation 112 of rotation between the flywheel 46 and dynamo 20. In certain embodiments, the rotor 62 of a dynamo 20 may actually be connected to move at all times that a flywheel 46 rotates. In such an embodiment, they may rotate together, and effectively the rotor 62 becomes part of the flywheel system 46. In other embodiments, as discussed hereinabove, clutching or other disengagement or gradual engagement between the dynamo 20 and a flywheel 46 may be used to gradually apply momentum from the flywheel 46 to the dynamo 20.

After the dynamo 20 is up to speed, and the momentum and energy have been stored in a flywheel 46, application 14 of an excitation voltage to the dynamo 20 is appropriate. At this point, excitation will tend to pull or cause a load on the dynamo 20. That is, once the dynamo 20 has an excitation voltage applied 114, it may then carry the appropriate load. However, only a modest amount of energy is required to apply 114 the excitation voltage to the dynamo 20.

Ultimately, application 116 of an electrical load to the dynamo 20 will produce substantial drag on the system 10. Applying 116 an electrical load 22 is effectively driving a motor or other mechanism drawing power from the dynamo 20. Ultimately a product, process, or the like will be powered by the motor. When the process is completed, the load 22 will be deactivated 118 or turned off 118. Finally, when all components have been shut off, including the excitation voltage, and so forth, as well as any rotating drivers such as the power source 12, the overall system 10 may be shut down 120 or turned off 120.

In the illustrated embodiment, urging 110 rotation of a flywheel 46 may include turning the system 10 to an “on” condition in an activation 122 or turning on 122 of the system 10. This may involve activating power and enabling mechanical movement of various elements of the system 10.

Likewise, initiation 124 of rotation of the power source 12 is typically accomplished by powering up a motor 12 or other power source 12. In certain embodiments, the power source 12 may be completely mechanical or hydrodynamic. Accordingly, rotation of the power source 12 typically will be followed by application 126 of rotation to a flywheel 46. Typically, application 126 of rotation to a flywheel 46 may be gradual, inasmuch as the massive, or comparatively massive energy and momentum of the flywheel 46 is a significant implemented. According, gradually applying 126 rotation to the flywheel 46 permits a further de-rating of the power source 12 to a device that would be unable to rotate the flywheel 46 directly without burning up.

Upon achievement 128 of an operational rotational speed for the flywheel 46, the urging 110 of the flywheel up to speed is completed. However, energy from the power source 12 must continue to be maintained in order to maintain rotation of the flywheel 46 within the operational range.

Imparting 112 rotation of the flywheel 46 to the dynamo 20 may be dispensed with in certain embodiments. That is, if the flywheel 46 and the dynamo 20 are permanently connected to rotate with one another, then the rotor 62 of the dynamo 20 acts as an additional flywheel element. However, if these are not rotating together, or in direct connection then application 130 of rotation between the flywheel and generator may be required through a clutch, slipping of belts 48, or the like. Ultimately, a desired rotational speed of the dynamo 20 may be achieved 132.

To accommodate transient conditions, excitation voltage may be applied 114 after of the proper rotational speed of the dynamo 20 is achieved 132. Again, if no load 22 is applied, application 114 of the excitation voltage should cause a comparatively minor disruption of the speed or slowing of the rotor 62. Ultimately, turning “on” 134 the excitation voltage, and adjusting 136 the excitation voltage will then provide the desired output capacity for the dynamo 20.

Applying 116 an electrical load 22 to the dynamo 20 may be the comparatively higher rated mechanical and electrical activity of the system 10. That is, because the load 22 will typically be a comparatively large motor having a higher rating, it is this very transient of applying 116 electrical load to the dynamo 20 that the flywheel 46 overcomes. Turning “on” 138 the load device 22 initiates a large current draw 140 on the dynamo 20. The effect is to tend to slow the dynamo 20. However, the stored energy in the energy storage device 16 and particularly a flywheel 46 may provide mechanical energy to the dynamo 20 to accommodate this large (comparatively) load on the system 10. Once this initial transient is overcome, the actual current draw by the load 22 may decrease to a total energy use that is within the output capability of the power source 12.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system comprising:
at least one flywheel
a first motor consuming electrical power, having a rating corresponding to a first maximum consumption of electrical power, and urging rotation of the flywheel; and
a dynamo generating electrical power, having a rating corresponding to a maximum production of electrical power, and receiving a rotational input from the flywheel, the maximum production being more than double the first maximum consumption.

2. The system of claim 1, wherein the first motor consumes single phase electrical power.

3. The system of claim 2, wherein the dynamo produces three phase electrical power.

4. The system of claim 3, wherein the system further comprises a load device consuming the electrical power generated by the dynamo.

5. The system of claim 4, wherein the load device comprises a second motor.

6. The system of claim 5, wherein:
the second motor has a rating corresponding to a second maximum consumption of electrical power; and
the second maximum consumption is more than double the first maximum consumption.

7. A system comprising:
at least one flywheel;
a first motor consuming electrical power, having a rating corresponding to a first maximum consumption of electrical power, and urging rotation of the flywheel;
a dynamo generating electrical power, having a rating corresponding to a maximum production of electrical power, and receiving a rotational input from the flywheel, the maximum production being more than double the first maximum consumption; and
a second motor consuming at least a portion of the electrical power generated by the dynamo and having a rating corresponding to a second maximum consumption of electrical power, the second maximum consumption being more than double the first maximum consumption.

8. The system of claim 7, wherein the second motor consumes substantially all of the electrical power generated by the dynamo.

9. The system of claim 8, wherein:
the first motor consumes single phase electrical power; and
the dynamo produces three phase electrical power.

10. A system comprising:
at least one flywheel;
a first motor consuming electrical power, having a rating corresponding to a first maximum consumption of electrical power, and urging rotation of the flywheel;
a dynamo comprising a stator and a rotor, the rotor comprising four poles each comprising a plurality of pole plates having a thickness of from about 0.050 inches to about 0.075 inches;
the dynamo generating electrical power, having a rating corresponding to a maximum production of electrical power, and receiving a rotational input from the flywheel, the maximum production being more than double the first maximum consumption; and
a second motor consuming at least a portion of the electrical power generated by the dynamo and having a rating corresponding to a second maximum consumption of electrical power, the second maximum consumption being more than double the first maximum consumption.
